(19) United States
(12) Patent Application Publication
(10) Pub. No.: US 2012/0060695 A1
(43) Pub. Date: Mar. 15, 2012

(54) AIR SUPPLY VENT FILTER FOR AIR CONDITIONING SYSTEMS

(76) Inventor: Helena Hepburn, Royal Palm Beach, FL (US)

(21) Appl. No.: 13/301,205

(22) Filed: Nov. 21, 2011

Related U.S. Application Data
(63) Continuation-in-part of application No. 12/284,753, filed on Sep. 25, 2008.

(51) Int. Cl. F24F 13/28; B01D 46/42

(52) U.S. Cl. 96/222; 55/501; 55/385.2

(57) ABSTRACT

A high-velocity-air filter apparatus for filtering air passing through air supply vents in air conditioning systems includes a metal wire grid support, a nylon mesh air filter that rests on top of the metal wire grid support, and a metal peripheral frame attached to and surrounding the peripheral edges of both of the metal wire grid support and the nylon mesh air filter. The high-velocity-air filter apparatus is washable, reusable, antibacterial and mildew-proof. The high-velocity-air filter apparatus minimizes the resistance to air-flow, allowing up to 125% of the nominal air flow rate through the air supply vent. The high-velocity-air filter apparatus is extremely thin, less than 0.1875 inches, to allow for maximum adaptability to air supply vents and to minimize air resistance.

This patent application is a Continuation-In-Part of co-pending patent application Ser. No. 12/284,753 filed on Sep. 25, 2008.

### BACKGROUND

Some embodiments may relate to air filters and, more particularly, to air filters for filtering air passing through air supply vents in air conditioning systems.

A significant percentage of the world's population suffers from various respiratory disorders, such as asthma and hay fever. While many of these people might be genetically predisposed to respiratory illness, the primary culprit is almost always airborne microbes and particulate that, when inhaled, trigger an attack. A great deal of attention has been given to outdoor environmental causes, including pollens, pollutants, and wind-blown dust particles from earthen materials. However, poor air quality of indoor environments is commonly the main cause of respiratory illness, particularly asthma and bronchitis.

Today most indoor spaces in homes and offices are cooled by central air conditioning systems that pull air from each room, through ducts, and to an HVAC handler unit. In the HVAC handler unit, the air is cooled by passing it over coils that are filled with a refrigerant. After cooling, the air is forced through supply ducts leading to supply vents within each room of the interior space. The cool air exits the supply vents and fills the interior living space in order to maintain a desired temperature level. When the air is pulled from the indoor living spaces and through the return ducts, the air is directed through one or more filters that trap some dust, dirt and germs before the returning air reaches the HVAC handler unit. The primary purpose of these filters is not to keep the air clean in the indoor living environment. Instead, these filters are meant to remove dust and dirt before the air reaches the evaporator coil and blower of the HVAC handler units so that the coils stay clean for efficient heat transfer. The cooled air that is sent back into the indoor spaces often contains dust, dirt and various microbes including mold, bacteria and fungus. Some of this particulate is pulled through the ducts during operation of the air conditioning system from crawl spaces, ceiling spaces and interior wall spaces that can never be cleaned. Microbes, such as mold, bacteria and fungus often grow within the ducts, particularly if moisture becomes trapped in the air supply system. Any dirt, dust, or microbes that enter or grow within the HVAC handler unit or cool air supply ducts will eventually be blown through the supply vents and into the indoor living environment. As noted above, these airborne particles and microbes are unhealthy and will cause respiratory illnesses including, but not limited to, asthma and bronchitis.

Accordingly, there remains an urgent and desperate need for a filter that is specifically adapted for placement within the air supply vents of an air conditioning system in order to remove dirt, dust, dust mites, mold, bacteria, mildew and fungus from the cool airflow prior to entering the indoor living environment.

While certain aspects of conventional technologies have been discussed and presented to facilitate disclosure of some embodiments, Applicants in no way disclaim these technical aspects, and it is contemplated that the attached claims may encompass one or more of the conventional technical aspects discussed herein.

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is it known to be relevant to an attempt to solve any problem with which this specification is concerned.

### SUMMARY

Some embodiments may address one or more of the problems and deficiencies discussed above. However, it is contemplated that some embodiments may prove useful in addressing other problems and deficiencies in a number of technical areas. Therefore the claims should not necessarily be construed as limited to addressing any of the particular problems or deficiencies discussed herein.

Some embodiments may include a high-velocity-air filter apparatus for filtering air passing through air supply vents in air conditioning systems that includes a metal wire grid support, a nylon mesh air filter that rests on top of the metal wire grid support, and a metal peripheral frame attached to and surrounding the peripheral edges of both of the metal wire grid support and the nylon mesh air filter. The high-velocity-air filter apparatus is washable, reusable, antibacterial and mildew-proof. The high-velocity-air filter apparatus minimizes the resistance to air-flow, allowing up to 125% of the nominal air flow rate through the air supply vent. The high-velocity-air filter apparatus is extremely thin, less than 0.1875 inches, to allow for maximum adaptability to air supply vents and to minimize air resistance.

An advantage provided by certain embodiments is that supply air delivered to a room from an air conditioning system is more effectively filtered and contains none to significantly less of any dust or other particulates that may have either passed the initial intake filter of the air conditioning system or that were introduced somewhere within the air conditioning system.

These and other advantages of some embodiments are more readily apparent with reference to the detailed description and accompanying drawings.

### BRIEF DESCRIPTION OF THE DRAWINGS

For a fuller understanding of the nature of some embodiments, reference should be made to the following detailed description taken in conjunction with the accompanying drawings in which:

FIG. 1 is a front perspective view of the metal wire grid support and the nylon mesh air filter according to an embodiment.

FIG. 2 is a front perspective view of the high-velocity-air filter apparatus according to an embodiment.

FIG. 3 is a bottom plan view of the high-velocity-air filter apparatus according to another embodiment including air freshener strips on the metal peripheral frame.

FIG. 4 is a front elevational exploded view of the air-delivery apparatus including an air conditioning duct, a ceiling, an air supply vent, and the high-velocity-air filter apparatus.

Like reference numerals refer to like parts throughout the several views of the drawings.

### DETAILED DESCRIPTION OF SOME EMBODIMENTS

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and do not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

All references herein to any features or elements of some embodiments such as but not limited to “a,” “an,” “one,” “an additional,” “another,” or “the” feature or element, or grammatical variations thereof, unless otherwise specified by limiting language such as “ONLY ONE . . .” wherein an exact number is specified along with the world “ONLY” or “LIMITED TO”, do NOT specifically prevent the inclusion or implementation of more than one of those features or elements, nor do they specifically admit that one or more of those features or elements must be used, unless otherwise specified by the limiting language “MUST have a” or “NEEDS to include one.”

All references herein including language such as but not limited to “one or more,” “at least one,” or grammatical variants thereof are nonlimiting and may be taken to mean that none of a certain feature or element may be used, or alternatively that only a singular feature or element may be used, or alternatively that only a plurality of elements or features may be used, or alternatively that either a singular or a plurality of features or elements may be used, or alternatively that none or one or more than one features or elements may be used. The use of this terminology herein does NOT specifically admit that more than one feature or element has to be used, nor does it specifically admit that only one feature or element has to be used, unless otherwise specified by the limiting language “MUST BE MORE THAN” or “CANNOT BE MORE THAN.” Therefore, whether or not a certain feature or element were limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . .” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” or variants thereof do NOT necessarily refer to the same embodiments. For example, language such as “some embodiments include a feature” followed by “some embodiments include an element” does NOT necessarily admit that both of the feature and the element are included in all of the same embodiments.

Unless otherwise specified, one or more particular features and/or elements described in connection with one or more embodiments may be found in one embodiment, or may be found in more than one embodiment, or may be found in all embodiments, or may be found in no embodiments.

Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any and all details set forth herein are used in the context of some embodiments and therefore should NOT be necessarily taken as limiting factors to the attached claims. Any descriptions of elements and/or features and/or the materials used to create those elements or features, or examples or methods included in the descriptions of the various embodiments are nonlimiting and are given as an illustration only. Accordingly, the embodiments can be manufactured, distributed, used, practiced, and carried out in numerous ways.

The attached claims and their legal equivalents can be realized in the context of embodiments other than the ones used as illustrative examples in the description herein.

Referring to the several views of the drawings, the high-velocity-air filter apparatus is shown in accordance with some embodiments. In each of these embodiments, the high-velocity-air filter apparatus is generally indicated as 10.

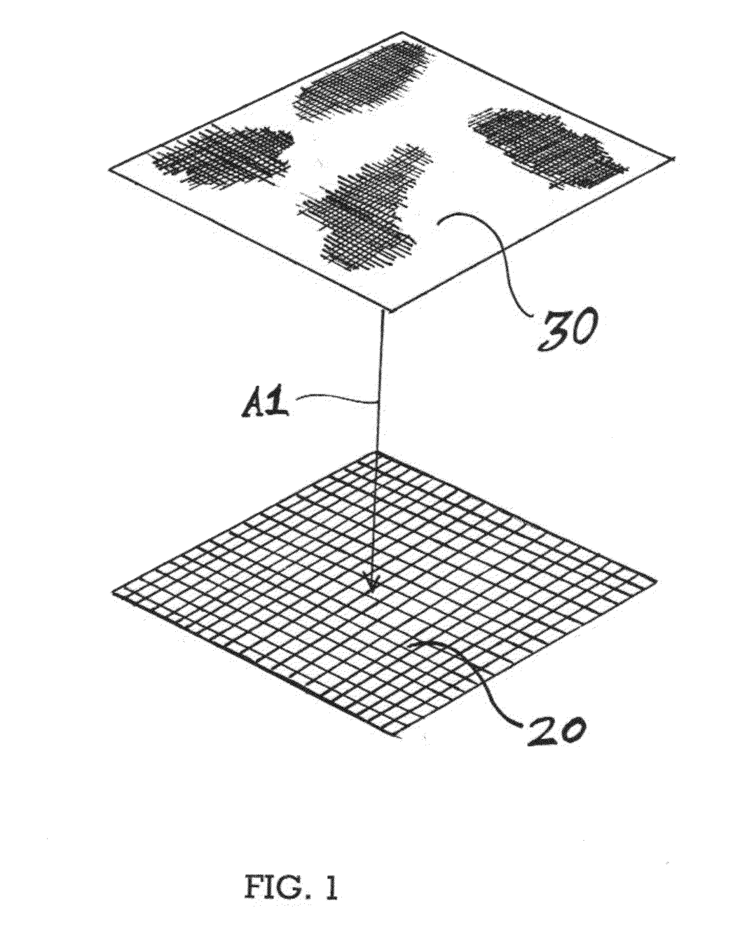

Reference is now made to FIG. 1, and in particular to the metal wire grid support 20 of FIG. 1. A metal wire grid support 20 may be made from galvanized steel, aluminum, stainless steel, or any combination thereof. Alloys defining combinations of multiple metals may also be used for the metal wire grid support 20. Additionally, any other suitably strong substance (such as plastic) may be envisioned as a possible material for the wire grid support 20. In some embodiments, the diameter of the wires of the wire grid support 20 may be exactly 0.0180 inches, or they may be between 0.0175 and 0.0185 inches, or they may be between 0.015 and 0.02 inches, or they may be below 0.015 inches, or they may be above 0.02 inches. In some embodiments, the mesh per linear inch of the wire grid support 20 may be exactly 12×12. In other embodiments, the mesh per linear inch may be lower than 12×12 or it may be higher than 12×12. In some embodiments, the width opening of the wire grid support 20 may be exactly 0.0653 inches. In other embodiments, the width opening of the wire grid support 20 may be between 0.06 and 0.07 inches, or between 0.05 and 0.1 inches, or below 0.05 inches, or above 0.1 inches. In some embodiments the metal wire grid support 20 may be defined as an electrostatic filter. In some embodiments the metal wire grid support 20 may be antibacterial, and it may be mildew-proof. In some embodiments, the metal wire grid support 20 may be washable. Any of the values for the various attributes of the metal wire grid support 20 may be considered changeable based on specific manufacturer and/or customer desires. As such, exact numbers mentioned herein must only be taken as example measurements, which may potentially be indicative of the optimal numbers to be used in practice, or alternatively may be indicative of non-optimal numbers to be used in practice.

Reference is still made to FIG. 1, and in particular to the nylon mesh air filter 30 of FIG. 1. The nylon mesh air filter 30 rests on top of the metal wire grid support 20, as indicated by the arrow Al. In some embodiments, the nylon mesh air filter 30 may be rated with an EN 779 class of G2. In some embodiments, the nylon mesh air filter 30 may be rated with a EUROVENT 4/5 class of EU2. In some embodiments, the nylon mesh air filter 30 may have an arrestance between 65% to 70%. In some embodiments, the nylon mesh air filter 30 may allow a maximum air flow rate of exactly 125% of the nominal air flow rate to pass through it. In other embodiments, the maximum air flow rate through the nylon mesh air filter 30 may be above 125% of the nominal air flow rate or below 125% of the nominal air flow rate. In some embodiments, the nylon mesh air filter 30 may allow an air flow rate of between 85% and 125% of the nominal air flow rate to pass through it. The nylon mesh air filter may have a maximum operating temperature of 60 degrees Celsius, in some embodiments. The nylon mesh air filter 30 may have a thickness of exactly 7.8 mm, or exactly 10 mm, or exactly 21 mm, or exactly 46 mm, in some embodiments. In other embodiments, the thickness of the nylon mesh air filter 30 may be below 7.8 mm, or between 7.8 mm and 10 mm, or between 10 mm and 21 mm, or between 21 mm and 46 mm, or above 46 mm. Any of the values for the various attributes of the nylon mesh air filter 30 may be considered changeable based on specific manufacturer and/or customer desires. As such, exact numbers mentioned herein must only be taken as example measurements, which may potentially be indicative of the optimal numbers to be used in practice, or alternatively may be indicative of non-optimal numbers to be used in practice.

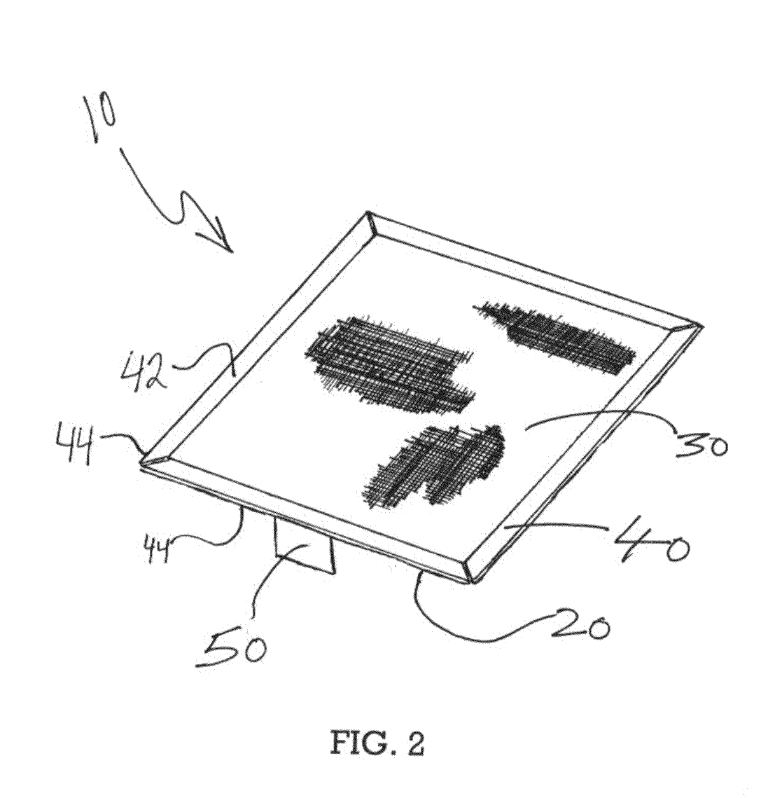

Additional reference is now made to FIG. 2. The high-velocity-air filter apparatus 10 is shown. A metal peripheral frame 40 is attached to both of the metal wire grid support 20 and the nylon mesh air filter 30. More specifically, the metal peripheral frame 40 is attached to and surrounds the peripheral edges of both of the metal wire grid support 20 and the nylon mesh air filter 30. The metal peripheral frame 40 is defined as having an upward-facing surface 42 and a downward-facing surface 44. In this particular sense, the term “upward-facing” is defined as meaning “facing towards the air conditioning duct, and in the opposite direction of the flow of air.” Similarly, “downward-facing” is defined as “facing away from the air conditioning duct and in the direction of the flow of air.” Of particular notice is that the nylon mesh air filter 30 may also be thought of as “upward-facing” since, in the view of FIG. 2, it is visible but the metal wire grid support 20 is not. That is, when viewing towards the upward-facing surface 42 of the metal peripheral frame 40, the nylon mesh air filter 30 is visible. Similarly, when viewing towards the downward-facing surface 44, the metal wire grid support 20 is visible. As may be seen in FIG. 2, the metal wire grid support 20 and the nylon mesh air filter 30 are pressed against each other and together, seemingly forming one layer. This “layer” is then secured by the attachment of the metal peripheral frame 40 around the layer's peripheral edges. In some embodiments, the metal wire grid support 20 may serve the purpose of supporting the nylon mesh air filter 30 from undergoing deformation over the course of time due to the high-velocity-airflow passing through it (i.e. the nylon mesh air filter 30 might start to stretch downward due to the force of the airflow against it, if not for the support of the sturdier, stronger metal wire grid support 20 which does not stretch due to the airflow). A tab 50 may extend downward (i.e. away from the air conditioning duct) out from the metal peripheral frame 40. The tab 50 may be grasped in order to more easily withdraw the high-velocity-air filter apparatus 10 from an air supply vent. The metal peripheral frame 40 and tab 50 may be made from galvanized steel, aluminum, stainless steel, or any combination thereof. Alloys defining combinations of multiple metals be also be used for the metal peripheral frame 40 and tab 50. Additionally, any other suitably strong substance (such as plastic) may be envisioned as a possible material for the metal peripheral frame 40 and tab 50. The overall dimensions of the high-velocity-air filter apparatus may vary based on manufacturer and/or customer needs. In some embodiments, the metal peripheral frame 40 may have dimensions of 6 inches×12 inches. In some embodiments, the dimensions may be different than 6 inches×12 inches. In some embodiments, the maximum bottom-to-top thickness of the high-velocity-air filter apparatus 10 may be between 0.01 and 0.1875 inches. In some embodiments, the maximum bottom-to-top thickness of the high-velocity-air filter apparatus 10 may be exactly 0.1875 inches, or exactly 0.15 inches, or exactly 0.1 inches, or below 0.1 inches, or between 0.1 and 0.15 inches, or between 0.15 and 0.1875 inches, or above 0.1875 inches.

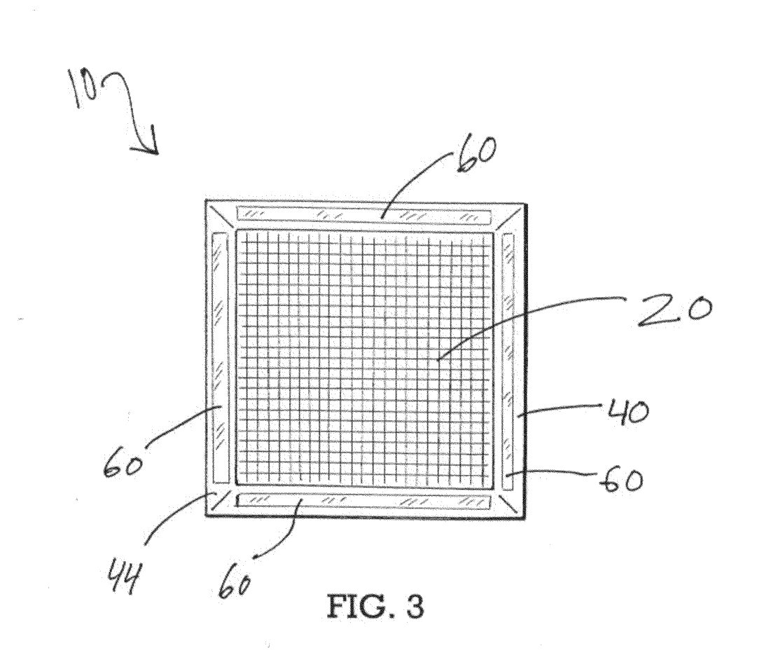

Additional reference is now made to FIG. 3. The high-velocity-air filter apparatus 10 is shown from a bottom plan view, such that the downward-facing surface 44 of the metal peripheral frame 40 is visible. Hence, the metal wire grid support 20 is visible. An air-freshener composition 60 may be applied to the downward-facing surface 44 in some embodiments. The air-freshener composition 60 is specifically structured and disposed to release a pleasant fragrance into the airflow passing through the filter apparatus 10 and exiting into the environment. The air-freshener composition 60 may define air-freshening strips, which may or may not have peelable protective films to be removed at the time of installation. The air-freshener composition 60 may be of any of a limitless amount of scents, depending on customer desire. The air-freshener composition 60 may define a plurality of disposable air-freshener adhesive strips that may be repeatedly applied, disposed of, and then replaced over the lifetime of a filter apparatus 10.

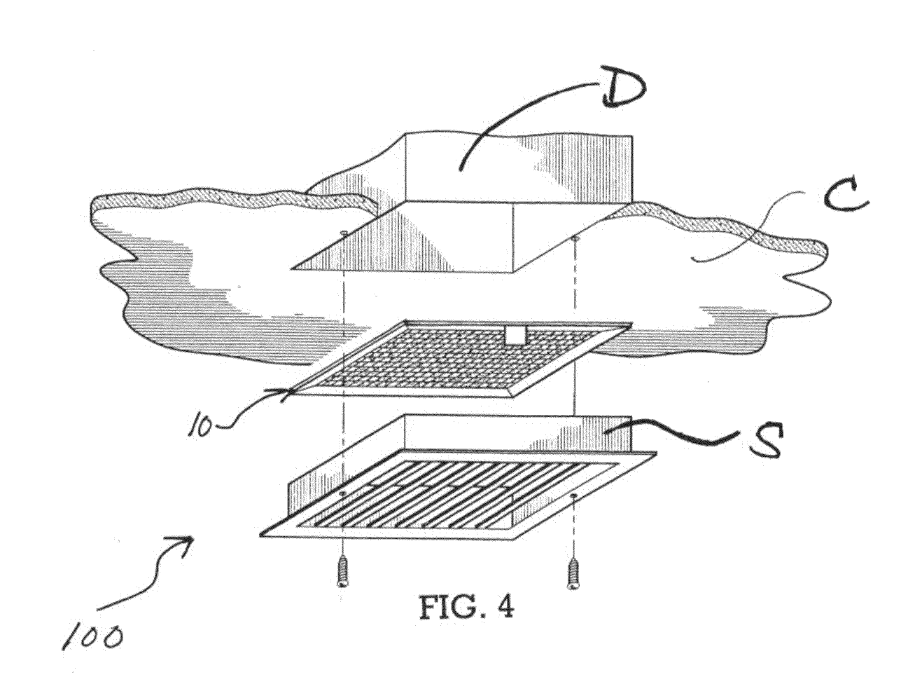

Additional reference is now made to FIG. 4. An air-delivery apparatus 100 is shown. The air-delivery apparatus 100 includes the high-velocity-air filter apparatus 10 and an air supply vent S. The high-velocity-air filter apparatus is housed within the air supply vent S. The air supply vent S is attached to at least one of the ceiling C and the air conditioning duct D such that cooled air exiting the air conditioning duct D is forced to pass through the high-velocity-air filter apparatus 10 before it may pass into the exterior atmosphere.

Throughout the detailed description and the accompanying drawings enclosed herein, some embodiments have been shown, described and detailed, wherein a variety of possible elements and/or features may be formed and configured in different ways. Accordingly, any and all possible combinations of the elements and/or features described in accordance with these various embodiments may be desirable to manufacturers and/or may help to more successfully meet customers' specific needs and/or preferences. Consequently, any and all possible combinations of the features or elements of one embodiment or more than one embodiment or all embodiments mentioned herein are fully considered within the spirit and scope of the attached claims and their legal equivalents.

Thus, some embodiments of high-velocity-air filter apparatus have been disclosed. Other embodiments are contemplated and envisioned, and therefore it is recognized that departures from the embodiments described in this disclosure may certainly exist within the spirit and scope of the attached claims and their legal equivalents. Those having an ordinary skill in the will envision other possible variations and modifications to features and/or elements of the embodiments, and they will envision other possible embodiments, all of which may fall within the spirit and scope of the attached claims. The spirit and scope of the attached claims is therefore NOT limited by the descriptions and illuminations of the embodiments that have already been presented, but rather the spirit and scope can only be defined by the attached claims and their legal equivalents as interpreted under the doctrine of equivalents. Variations, alternatives, adjustments, modifications, tunings, and deviations from the embodiments of the instant disclosure are fully contemplated and envisioned within the spirit and scope of the attached claims.

What is claimed is:

1. A high-velocity-air filter apparatus for filtering air passing through air supply vents in air conditioning systems comprising:
a metal wire grid support;
a nylon mesh air filter that rests on top of the metal wire grid support, wherein the nylon mesh air filter has an arrestance of between 65% and 70%;
a metal peripheral frame attached to both of the metal wire grid support and the nylon mesh air filter and surrounding the peripheral edges of both of the metal wire grid support and the nylon mesh air filter;
a tab extending downward from the metal peripheral frame towards the exit of the air supply vent, wherein the tab causes the high-velocity-air filter apparatus to be removed from the air supply vent if a person grasps the tab and pulls downward on it with the required force;
wherein the high-velocity-air filter apparatus is washable and reusable;
wherein the high-velocity-air filter apparatus is capable of allowing an air flow rate out of the air supply vent of between 85% and 125% of the nominal air flow rate; and
wherein the high-velocity-air filter apparatus is antibacterial and mildew-proof.

2. The high-velocity-air filter apparatus as recited in claim 1 wherein the maximum bottom-to-top thickness of the high-velocity-air filter apparatus is between 0.01 and 0.1875 inches.

3. The high-velocity-air filter apparatus as recited in claim 1 wherein the nylon mesh air filter is rated with an EN 779 class of G2.

4. The high-velocity-air filter apparatus as recited in claim 1 wherein the nylon mesh air filter is rated with a EUROVENT 4/5 class of EU2.

5. A high-velocity-air filter apparatus for filtering air passing through air supply vents in air conditioning systems comprising:
at least one filter mesh having an arrestance of between 65% and 70%;
a metal peripheral frame attached to the at least one filter mesh and surrounding the peripheral edge of the at least one filter mesh;
wherein the high-velocity-air filter apparatus is washable and reusable;
wherein the high-velocity-air filter apparatus is capable of allowing an air flow rate out of the air supply vent of between 85% and 125% of the nominal air flow rate; and
wherein the maximum bottom-to-top thickness of the high-velocity-air filter apparatus is between 0.01 and 0.1875 inches.

6. An air-delivery apparatus for delivering cooled air from an air conditioning duct to a room comprising:
an air supply vent;
a high-velocity-air filter apparatus for filtering air passing through air supply vents in air conditioning systems comprising:
a metal wire grid support;
a nylon mesh air filter that rests on top of the metal wire grid support, wherein the nylon mesh air filter has an arrestance of between 65% and 70%;
a metal peripheral frame attached to both of the metal wire grid support and the nylon mesh air filter and surrounding the peripheral edges of both of the metal wire grid support and the nylon mesh air filter;
a tab extending downward from the metal peripheral frame towards the exit of the air supply vent, wherein the tab causes the high-velocity-air filter apparatus to be removed from the air supply vent if a person grasps the tab and pulls downward on it with the required force;
wherein the high-velocity-air filter apparatus is washable and reusable;
wherein the high-velocity-air filter apparatus is capable of allowing an air flow rate out of the air supply vent of between 85% and 125% of the nominal air flow rate; and
wherein the high-velocity-air filter apparatus is antibacterial and mildew-proof;
wherein the high-velocity-air filter apparatus rests within the air supply vent; and
wherein the air supply vent is attached to at least one of the ceiling and the air conditioning duct in such a way that the cooled air is forced to pass through the high-velocity-air filter apparatus before it is transferred to the room.

7. The air-delivery apparatus as recited in claim 6 wherein the maximum bottom-to-top thickness of the high-velocity-air filter apparatus is between 0.01 and 0.1875 inches.

8. The air-delivery apparatus as recited in claim 6 wherein the nylon mesh air filter is rated with an EN 779 class of G2.

9. The air-delivery apparatus as recited in claim 6 wherein the nylon mesh air filter is rated with an EUROVENT 4/5 class of EU2.

10. The air-delivery apparatus as recited in claim 6 wherein the metal wires of the metal wire grid support have a diameter of between 0.0175 and 0.0185 inches.

11. The air-delivery apparatus as recited in claim 6 wherein the width opening of the metal wire grid is between 0.06 and 0.07 inches.

12. The high-velocity-air filter apparatus as recited in claim 1 further comprising:
an air freshener composition applied to the peripheral frame and formulated for releasing a fragrance into a flow of air passing through the filter apparatus.

13. The air-delivery apparatus as recited in claim 6 further comprising:
an air freshener composition applied to the peripheral frame and formulated for releasing a fragrance into a flow of air passing through the filter apparatus.
